(19) United States
(12) Patent Application Publication
(10) Pub. No.: US 2014/0060387 A1
(43) Pub. Date: Mar. 6, 2014

(54) Method For Preparing Admixture Blends For Construction Material On Site And A Micro-Plant For Implementing The Method

(71) Applicants: Sven Asmus, Shanghai (CN); Masayori Fujioka, Shanghai (CN); Jan Kluegge, Shanghai Pudong (CN)

(72) Inventors: Sven Asmus, Shanghai (CN); Masayori Fujioka, Shanghai (CN); Jan Kluegge, Shanghai Pudong (CN)

(73) Assignee: CONSTRUCTION RESEARCH & TECHNOLOGY GMBH, Trostberg (DE)

(21) Appl. No.: 13/990,552

(22) PCT Filed: Dec. 6, 2010
(86) PCT No.: PCT/CN2010/079470

§ 371 Date: Aug. 27, 2013

(51) Int. Cl. C04B 40/00

(52) U.S. Cl. CPC C04B 40/0039
USPC 106/638

(57) ABSTRACT

The present invention discloses a method for preparing admixture blends for construction material on site, which comprises the steps of: a) selecting at least one kind of raw material for formulating out an admixture blend and providing a water supply on site; b) controlling the usage amount of said at least one kind of raw material and water on site according to construction material performance requirement; c) mixing the predetermined amount of raw materials and water on site; and d) directly supplying the obtained admixture blend to a manufacturing apparatus for construction material on a construction material manufacturing site, wherein the whole process of preparation is completed with the online control from a computer. The present invention also discloses a mobile micro-plant for implementing the method.

### TECHNICAL FIELD

The present invention generally relates to a method for preparing admixture blends for construction material on site, specifically, to a method for preparing concrete admixture blends on site. It is also related to a mobile micro-plant for implementing the method.

### BACKGROUND

In construction field it is known to use as small amount of chemical admixtures during the process of preparing construction materials such as concrete, mortar and cement so as to change or improve properties of final product of construction materials. Concrete admixture is a kind of material added into concrete prior to or during the mixing of concrete, so as to ameliorate properly of newly blended concrete product, such as dispersibility, hardened speed, air-entraining or workability. Therefore, during the process of preparing concrete, it is a significant measurement for the optimization of concrete formulations and the enhancement of durability of concrete product to add appropriate admixtures in an appropriate manner. The dose accuracy and blend uniformity of the admixtures are also critical to the concrete production.

Conventionally used admixtures for hydraulic concrete include water reducing admixture, set retarder admixture, air-entraining admixture, and composite admixtures such as set retarding and water reducing admixture, retarding superplasticizer, hardening accelerating and water reducing admixture, air entraining and water reducing admixture and so on.

At present, because of diversifying demands of concrete properties, concrete admixture producers have to vary compositions of admixture blends according to the requirement of concrete manufacturer, and then pack the prepared admixture blend in tanks and send the packed admixture blend to warehouses of the concrete manufacturer for future use, or send the prepared admixture blend as bulk to tanks of the concrete manufacturer for feature use.

As for the current preparation and transportation of the admixture blend, there are many disadvantages. For example, during the process of preparing an admixture blend, water is always required to dissolve solid components of admixture or to dilute raw materials of admixture (admixture composition); however, because usually tap water is used as industrial water, it is thus inevitable to bring some foreign bacteria into the admixture blend. Normally, the admixture blend packed or stored in tanks presents a low solid content, and its storage and transportation process always takes a long time, which therefore provides a favorable condition for the growth of bacteria and mold. Undesirably, the propagation of bacteria and mold will necessarily result in instability or degradation of the properties of pre-mixed admixtures. In order to prevent growing-up of such bacteria and mold, biocides or pesticide will be added into the admixture blend excessively. In most cases, over-addition of biocides or pesticide will be the source of unnecessary waste.

In addition, the current storage and supply system of admixture blends is not satisfactory in terms of flexibility. Once the concrete manufacturer demands to change concrete property to adapt to practical needs, the packed or stored admixture prepared according to previous requirement is unable to meet the new demand, and consequently, the admixture producer has to cooperate to re-prepare admixture blends based on newly designed formulation. Hence, in doing so, huge loss of manpower and material resources will occur. Further, additional warehousing is required in proximity to the concrete manufacture site for storing prepared admixture blends from the admixture producer, which will lead to an increase in production cost for the concrete manufacturer.

The present invention is directed to overcoming one or more of the problems set forth above.

### SUMMARY

Specifically stated, the present disclosure aims to provide a method for preparing admixture blends for construction material on site, which enables to transport stable admixture compositions of high solid contents (shipping less water) with less biocide or without biocide, and to allow an excellent flexibility for admixture supply and very quick modification of admixture blends. Besides, by means of the disclosed method, the cost for transportation and for storage warehousing will be largely reduced. Especially, with this disclosed method, dosage and supply of the admixture compositions can be implemented accurately, timely and efficiently.

In one aspect, the present disclosure provides a method for preparing admixture blends for construction material on site (at the construction material manufacturing site), which comprises the steps of:
a) selecting at least one kind of raw material for formulating out an admixture blend and providing a water supply on site;
b) controlling the usage amount of said at least one kind of raw material and water on site according to construction material performance requirement;
c) mixing the predetermined amount of raw materials and water on site; and
d) directly supplying the obtained admixture blend to a manufacturing apparatus for construction material,
wherein the whole process of preparation is completed with the online control from a computer.

Preferably, the whole process of preparation is carried out in a closed system with respect to the construction material manufacturing site, such that the admixture producer can flexibly change components or formulations of admixture blends according to product performance requirement on site, and admixture information is strictly kept in secrecy for the construction material manufacturer.

In a particular embodiment, said at least one kind of raw material is an admixture of high solid content. In this case, the method of the present invention is particularly favorable. This is because a significant reduction in transportation cost can be obtained by the disclosed method.

Preferably, said at least one kind of raw material is selected from the group consisting of water reducing admixture, slump retainer, set retarder, air entraining admixture, air defoamer, shrinkage-reducing agent or hardening accelerator.

In a specific embodiment, said step b) comprises metering said at least one kind of raw material and water by one or more flowmeters. In this way, accurate proportioning of admixture compositions can be achieved.

In a specific embodiment, said step c) comprises mixing with a stirrer controlled by a computer-based controller. It is thus possible to produce uniformly mixed admixture blend by controlling the mixing time of the stirrer.

Preferably, said construction material is concrete, cement or mortar.

In another aspect, the present invention provides a mobile micro-plant for implementing the above said method, comprising: an admixture raw materials supply module including one or more raw material containers filled with admixture raw materials, a water line for supplying water, a pumping module including one or more pumps for pumping raw material flows from said raw material containers, a valve module including one or more valves for controlling raw material flows and water flow, a metering module including one or more flowmeters for metering raw material flows and water flow, a mixing module for mixing the metered raw materials and water, and a computer-based controller for controlling the operation of said pumping module, said valve module, said metering module and said mixing module.

### BRIEF DESCRIPTION OF THE DRAWINGS

Accompanying drawings which are incorporated in and constitute one part of this specification illustrate examples of preferred embodiments of the present disclosure and, along with the description, serve to explain the principles of the present disclosure, in which

FIG. 1 shows a first embodiment of the micro-plant for implementing the method according to the present invention;

FIG. 2 shows a second embodiment of the micro-plant for implementing the method according to the present invention; and

FIG. 3 schematically shows a process for preparing admixture blends.

### DETAILED DESCRIPTION OF THE PREFERRED EMBODIMENTS

Preferred embodiments of the present disclosure will be described in details with a reference to accompanying drawings that are included. Like numerals will be used to indicate like components throughout the accompanying drawings, if possible.

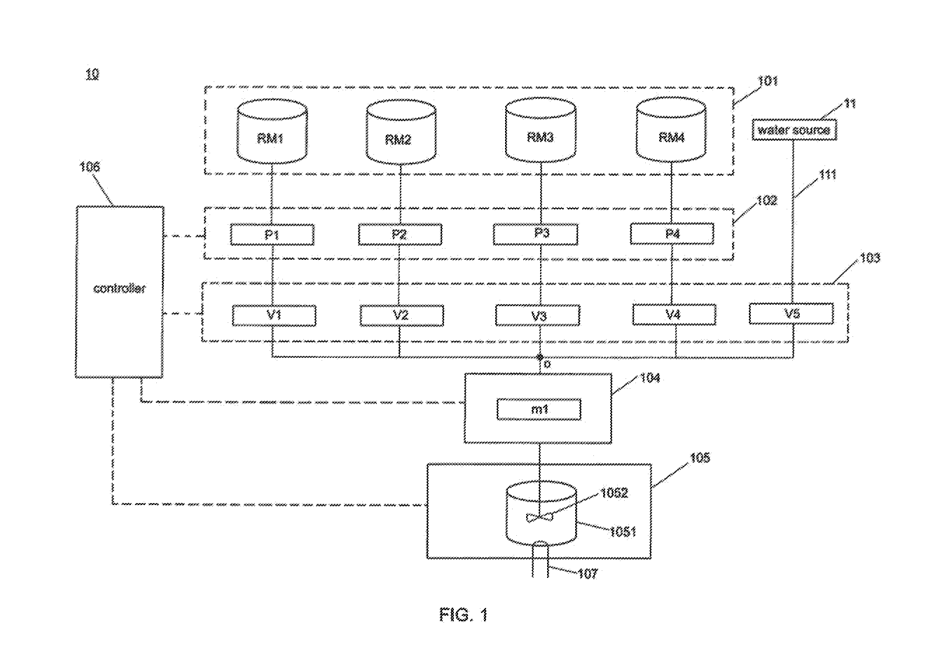

A micro-plant 10 for producing concrete admixture blends as shown in FIG. 1 is installed or placed at construction material manufacturing site, i.e. nearby a concrete plant, comprising: an admixture raw material supply module 101 including one or more raw material containers filled with admixture raw materials; a water line 111 connected with a water source 11 for supplying water; a pumping module 102 including one or more pumps in fluid communication with the raw material containers of the admixture raw material supply module via pipelines; a valve module 103 including one or more valves connected with the pumps of the pumping module via pipelines and arranged downstream of each pump, and an valve located in the water line; a metering module 104 arranged downstream of the valve module 103 and including flowmeters; a mixing module 105 arranged downstream of the metering module and including a mixing container 1051 for holding the metered admixture raw materials and water and a stirrer 1052 for mixing; and a controller 106 controlling operation of the pumping module 102, the valve module 103, the metering module 104 and the mixing module 105.

All the modules of the micro-plant may be assembled together to form a transportable or mobile plant of integral type.

Although it is schematically shown in the drawing that in the admixture raw material supply module 101 there are four raw material containers RM1, RM2, RM3, RM4, and accordingly the pumping module 102 has four pumps P1, P2, P3, P4, the valve module 103 includes four valves V1, V2, V3, V4 in connection with the pumps of the pumping module via pipelines and a valve V5 located in the water line, it is easy for a person skilled in the art to conceive that the number of the raw material containers in the admixture raw material supply module can be freely set according to practical needs, rather than limited to this embodiment.

Preferably, the flowmeter can be embodied as a Coriolis mass flowmeter.

The admixture raw material is selected from water reducing admixture, slump retainer, set retarder, air entraining admixture, air defoamer, shrinkage-reducing agent, or hardening accelerator, etc. Normally, the admixture raw material is a solution of high solid content, namely, its water content is low or little. Therefore, the admixture producer needs to deliver only admixture raw materials of high solid contents to the construction material manufacturing site in time rather than to provide pre-mixed and packed products made by dosing and mixing of proportioned admixture raw materials in the central plant at the admixture producer's site. Normally, the solid content of the pre-mixed product is not high, the highest being 35%, normally about 20% to 25%. Thus, the present invention greatly decreases transportation cost, particularly cost of water delivery, and avoid the problem of bacteria growth caused by high water content.

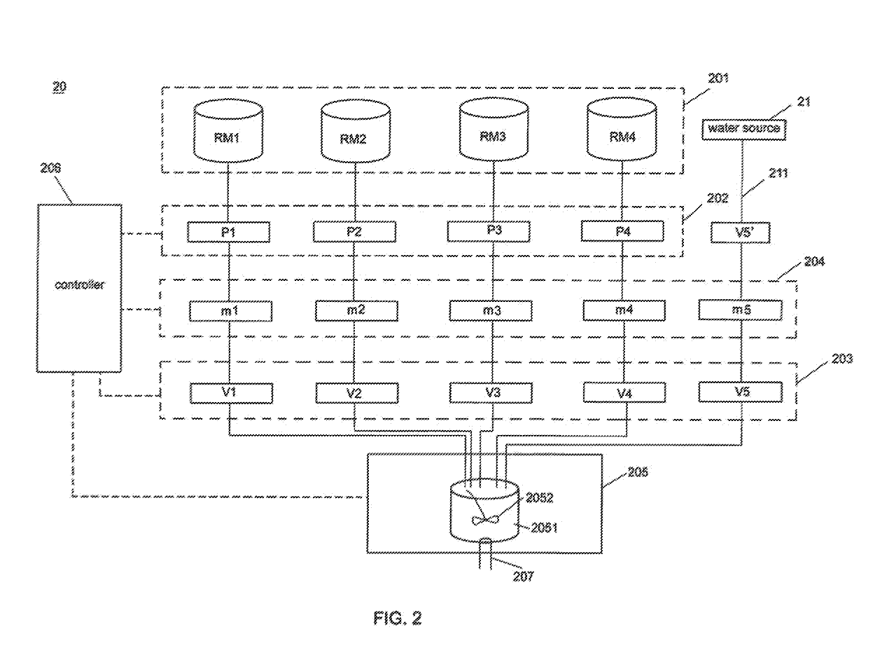

FIG. 2 shows a micro-plant 20 of another embodiment according to the present invention. It can be seen from the figure that the micro-plant 20, as compared with the micro-plant 10, is similarly provided with: an admixture raw material supply module 201, a water line 211 connected with a water source 21 for supplying water, a pumping module 202, a valve module 203, a metering module 204, a mixing module 205 including a mixing container 2051 and a stirrer 2052, a controller 206 for controlling the operation of the pumping module 202, the valve module 203, the metering module 204 and the mixing module 205. Whereas the difference between the two micro-plants lies in: in the micro-plant 10 of the first embodiment, pipelines extending from the valves of the valve module 103 meet at point O and then extend therefrom to the sole flowmeter m1 in the metering module 104; while in the micro-plant 20 of the second embodiment, each of the pipelines extending downstream from the pumps p1, p2, p3, p4 of the pumping module 202 is connected to a valve v1, v2, v3, v4 of the valve module 203 through a flowmeter m1, m2, m3, m4 of the metering module 204 provided therebetween, and in the waterline 211 there is a valve v5′ provided upstream of the flowmeter m5 in the metering module 204 and downstream of the water source 21 for protecting the flowmeter m5 from being damaged due to very high hydraulic pressure in the water line. A valve v5 of the valve module 203 is provided downstream of the flowmeter m5 for better control of the water flow and set to have the same timing of that of the valve v5′. Therefore, in the first embodiment, all the raw materials flow and water flow are metered in sequence by the sole flowmeter before entering into the mixing tank of the mixing module, while in the second embodiment the raw materials flow and water flow can be metered in sequence or simultaneously.

In order to supply on the spot the uniformly mixed admixture blend to the manufacturing apparatus of construction material, the mixing containers 1051, 2051 of the mixing modules 105, 205 are connected with discharging pipelines 107, 207.

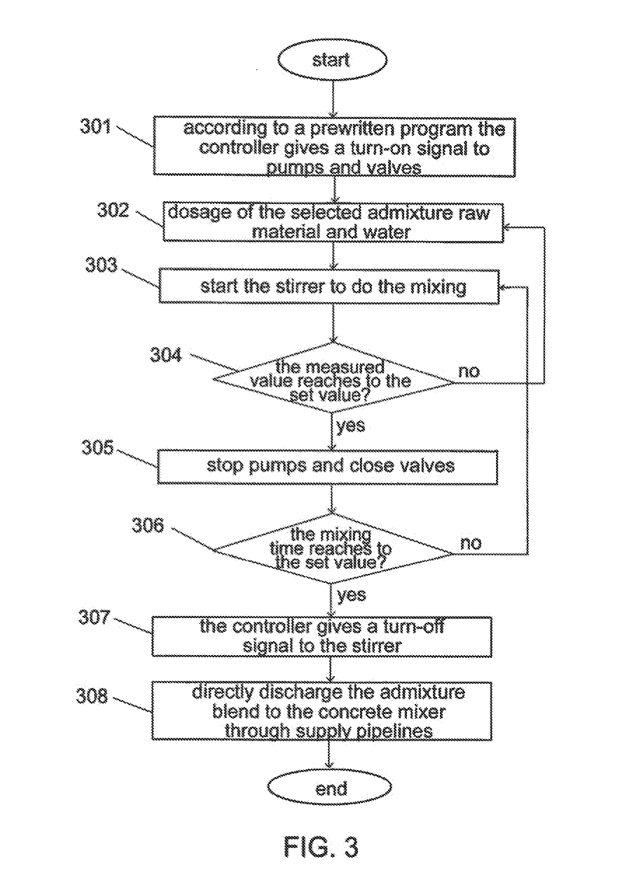

Based on the micro-plant 20 shown in FIG. 2 and the process for preparing admixture blends shown in FIG. 3, how to prepare and supply admixture blends via on-line according to demand is described in detail as follows:

First of all, a micro-plant according to the present invention is installed at a construction material manufacturing site. Normally, according to specific performance requirement for the construction material, the admixture raw material is delivered in advance to the construction material manufacturing site. Of course, the number and categories of the delivered admixture raw materials may change according to requirements at construction material manufacturing site. Thus, the admixture producer can change the formulation of admixture blends depending on the process demand, without worrying about shortage in the supply of raw materials.

Then, the supplied at least one kind of admixture raw material is tanked in the raw material containers of the admixture raw material supply module of the micro-plant.

The controller is controlled by a computer on line and is in electrical communication with all the pumps of the pumping module and all the valves of the valve module and the stirrer in the mixing module. A prewritten program is input into the computer or controller and then the controller gives the turn-on signal to the specified pumps and valves (step 301). Accordingly, admixture raw materials flow through respective pipelines via the opened pumps and valves so that the dosage of selected admixture raw materials is started, and furthermore, the valve in the water line is opened so that dosage of water flow can be conducted by a flowmeter (step 302). Finally, the weight of admixture raw materials (including water) is measured by corresponding flowmeters.

Then, the controller starts the stirrer in the mixing module to blend the admixture raw materials in the mixing container (step 303).

The flowmeters send the measured weight information to the controller, by which it is determined whether the measured weight reaches to a set value (step 304). When the weight reaches to the set value, the controller sends turn-off signals to respective pumps and valves (step 305), such that the dosage of admixture raw materials is stopped. If the measured weight does not reach to the set value, the dosage continues.

In addition, the controller determines whether the time period for mixing reaches to a pre-set value (step 306). If the time period reaches the pre-set value, the controller sends turn-off signals to the stirrer to stop mixing (step 307) and if not, the mixing continues.

Then, the mixed admixture blend is directly supplied to a construction material manufacturing equipment through a pipeline and discharging pump (step 308).

Thereby, both preparation and supply of admixture blend are accomplished at the construction material manufacturing site.

Actually, the construction material manufacturing site may need more than one admixture blends. For the purpose of meeting the widely-varied demands, admixture producer can quickly make a new program based on another formulation designed at the request of the construction material manufacturing site, and input this new program via internet into the computer that controls the controller. Of course, the new program can also be manually input by an admixture producer on a construction material manufacturing site. Accordingly, the controller acts to start different pumps and valves and to control the stirrer according to the input of a mixing time set by the program, so that another admixture blend can be prepared as desired.

In the micro-plant, the sequence of flowmeters, pumps and valves provided in the pipelines extending from each raw material container to the mixing container can be changed instead of being restricted to the sequence as shown in FIG. 1 and FIG. 2. For example, in an embodiment modified based on that of FIG. 2, valves can be provided between pumps and flowmeters in each pipeline.

The admixture raw materials can be metered and mixed conveniently on site through a micro-plant installed at the construction material manufacturing site, such that the problem of stratification of pre-mixed tanked admixture caused by long storage time can be solved and risk of false operation can be avoided. In particular, through internet remote control, resource distribution can be optimized, with flexibility of operation being increased, service quality being improved, risk of commercial secret disclosure being avoided and market competitiveness being strengthened as well.

It will be apparent to those skilled in the art that various modifications and variations can be made to the disclosed method and the disclosed micro-plant for the method without departing from the scope of the disclosure. Other embodiments of the invention will be apparent to those skilled in the art from consideration of the specification and practice disclosed herein. It is intended that the specification and examples be considered as exemplary only, with a true scope of the disclosure being indicated by the following claims and their equivalents.

1. A method for preparing admixture blends for construction material on site, including the steps of:
a) selecting at least one kind of raw material for formulating out an admixture blend and providing a water supply on site;
b) controlling the usage amount of said at least one kind of raw material and water on site according to construction material performance requirement;
c) mixing the predetermined amount of raw materials and water on site; and
d) directly supplying the obtained admixture blend to a manufacturing apparatus for construction material on a construction material manufacturing site,
wherein the whole process of preparation is completed with the online control from a computer.

2. The method as claimed in claim 1, wherein the whole process of preparation is carried out in a closed system with respect to the construction material manufacturing on site.

3. The method as claimed in claim 1, wherein said at least one kind of raw material is an admixture of high solid content.

4. The method as claimed in claim 1, wherein said at least one kind of raw material is selected from the group consisting of water reducing admixture, slump retainer, set retarder, air entraining admixture, air defoamer, shrinkage-reducing agent and hardening accelerator.

5. The method as claimed in claim 1, wherein said step b) comprises metering said at least one kind of raw material and water by one or more flowmeters.

6. The method as claimed in claim 1, wherein said step c) comprises mixing with a stirrer controlled by a computer-based controller.

7. The method as claimed in claim 1, wherein said construction material is concrete, cement or mortar.

8. A mobile micro-plant for implementing the method as claimed in claim 1, comprising: an admixture raw material supply module including one or more raw material containers filled with admixture raw materials, a water line for supplying water, a pumping module including one or more pumps for pumping raw material flows from said raw material containers, a valve module including one or more valves for controlling raw material flows and water flow, a metering module including one or more flowmeters for metering raw material flows and water flow, a mixing module for mixing the metered raw materials and water, and a computer-based controller for controlling the operation of said pumping module, said valve module, said metering module and said mixing module.
